(19) United States
(12) Patent Application Publication
(10) Pub. No.: US 2025/0232929 A1
(43) Pub. Date: Jul. 17, 2025

(54) KEYBOARD WITH INTEGRATED GASKET

(71) Applicant: Logitech Europe S.A., Lausanne (CH)

(72) Inventors: Jhan-Li Wu, Hsinchu City (TW); Wai Bun Choi, Hsinchu City (TW); Szu-Ting Lan, Tainan City (TW)

(21) Appl. No.: 18/412,469

(22) Filed: Jan. 13, 2024

(51) Int. Cl. H01H 13/70; G06F 1/16; H01H 13/06

(52) U.S. Cl. CPC H01H 13/70; G06F 1/1662; H01H 13/06

(57) ABSTRACT

A switch plate for a computer peripheral device. The switch plate includes a substrate having an upper surface and a lower surface, wherein the substrate comprises a rigid polymeric material. The switch plate including a gasket coupled with the lower surface of the substrate. The gasket comprises a resilient polymeric material. The substrate and the gasket are co-molded.

### BACKGROUND

Input devices are commonplace in modern society and are typically used to convert human-induced analog inputs (e.g., touches, clicks, motions, touch gestures, button presses, scroll wheel rotations, etc.) made in conjunction with an input device into digital signals for computer processing. An input device can include any device that can provide data and control signals to a computing system. Some non-limiting examples of input devices include computer mice, keyboards, virtual reality and/or augmented reality controllers, touch pads, remote controls, gaming controllers, joysticks, trackballs, and the like. Some non-limiting examples of computing systems include desktop computers, laptop computers, netbook computers, gaming consoles, tablets and “phablet” computers, smart phones, personal digital assistants, wearable devices (e.g., smart watches, glasses), virtual reality (VR) and/or augmented reality (AR) headsets and systems, and the like.

Input devices have undergone many marked improvements over the last several decades. In some contemporary input devices, such as mice, keyboards, and controllers, a gasket may be incorporated to reduce the shock and force applied to components of the input device and modify the input feel of input devices. However, current gaskets may add unnecessary complexity to the manufacturing process of input devices and may lack abilities related to reducing sound, vibrations, force on input device components, and manufacturing time of the input device. As such, better solutions are needed.

Unless otherwise indicated herein, the materials described in this section are not prior art to the claims in this application and are not admitted to be prior art by inclusion in this section.

### BRIEF SUMMARY

In certain embodiments, a switch plate for a computer peripheral device includes a substrate having an upper surface and a lower surface, wherein the substrate comprises a rigid polymeric material. The switch plate may further include a gasket coupled with the lower surface of the substrate. The substrate and the gasket may be co-molded. The gasket may comprise a resilient polymeric material.

In certain embodiments, a keyboard includes a switch plate. The switch plate may include a substrate having an upper surface and a lower surface, wherein the substrate comprises a rigid polymeric material. The switch plate may include a gasket coupled with the lower surface of the substrate. The gasket and the substrate may be co-molded. The gasket may comprise a resilient polymeric material. The switch plate may define a set of key apertures through a thickness of the switch plate. A printed circuit board (PCB) may be disposed below the switch plate. A set of key switches may be mounted on the PCB. Each of the set of key switches may extend through a respective one of the set of key apertures. The keyboard may include a bottom case that supports the PCB and the switch plate.

In certain embodiments, a computer peripheral device includes a switch plate. The switch plate may include a substrate having an upper surface and a lower surface, a gasket coupled with the lower surface of the substrate, and at least one light emitting element disposed beneath the switch plate. The switch plate may include a light transmission region. The at least one light emitting element may be disposed beneath the light transmission region. The substrate may comprise a rigid polymeric material. The substrate and the gasket may be co-molded. The gasket may comprise a resilient polymeric material.

The terms and expressions that have been employed are used as terms of description and not of limitation, and there is no intention in the use of such terms and expressions of excluding any equivalents of the features shown and described or portions thereof. It is recognized, however, that various modifications are possible within the scope of the systems and methods claimed. Thus, it should be understood that, although the present system and methods have been specifically disclosed by examples and optional features, modification and variation of the concepts herein disclosed should be recognized by those skilled in the art, and that such modifications and variations are considered to be within the scope of the systems and methods as defined by the appended claims.

This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim.

The foregoing, together with other features and examples, will be described in more detail below in the following specification, claims, and accompanying drawings.

### BRIEF DESCRIPTION OF THE DRAWINGS

The features of the various embodiments described above, as well as other features and advantages of certain embodiments of the present invention will be more apparent from the following detailed description taken in conjunction with the accompanying drawings, in which:

FIG. 1 illustrates an example of a computer system that can include any of a variety of host computing devices and computer peripheral devices, including computer peripheral devices (e.g., a computer mouse, keyboard, etc.) that can be configured to perform aspects of the various inventive concepts described herein;

FIGS. 2A-2B illustrate simplified exploded views of keyboard systems;

FIG. 3 illustrates a simplified diagram of a switch plate, according to certain embodiments;

FIG. 4 illustrates a cross section of an example simplified diagram of a computer peripheral device, according to certain embodiments;

FIG. 5 illustrates a cross section of an example simplified diagram of a keyboard, according to certain embodiments;

FIGS. 6A-E illustrate cross sections of example switch plates, according to certain embodiments;

FIGS. 7A-B illustrate examples of a gasket co-molded with a substrate;

FIGS. 8A-B illustrate examples of a gasket co-molded with a substrate;

FIG. 9 illustrates an example of a gasket extending through a button aperture; and

FIG. 10 illustrates an example of a gasket being used to provide structural features of a peripheral device.

### DETAILED DESCRIPTION

Aspects of the present disclosure relate generally to electronic devices, and more particularly to computer peripheral devices that utilize a gasket for improved noise reduction, improved vibration reduction, improved sealing, increased simplicity of manufacturing, reduction of force on other components of the computer peripheral device, and reduction of part count.

In the following description, various examples of devices utilizing gasket technologies are described. For purposes of explanation, specific configurations and details are set forth in order to provide a thorough understanding of the embodiments. However, it will be apparent to one skilled in the art that certain embodiments may be practiced or implemented without every detail disclosed. Furthermore, well-known features may be omitted or simplified to prevent any obfuscation of the novel features described herein.

The following high level summary is intended to provide a basic understanding of some of the novel innovations depicted in the figures and presented in the corresponding descriptions provided below. Aspects of the invention relate to various improved computer peripheral devices and electronic devices more generally (also referred to as input devices) that incorporate switch plate and/or gasket, as described in the embodiments that follow. An input device, as noted above, is typically used to convert human-induced analog inputs (e.g., touches, clicks, motions, touch gestures, button presses, scroll wheel rotations, etc.) made in conjunction with the input device into digital signals for computer processing. A button (e.g., used in a computer mouse, remote control, game controller, etc.) or key (e.g., used on a keyboard) are common depressible elements that can be depressed and/or otherwise manipulated by a user to instantiate a type of control signal (e.g., an alphanumeric character, a left/right mouse button, a trigger, etc.). During a button, key, or other element being depressed by the user, force is exerted from the user on the computer peripheral device. In systems today, gaskets may be included in the computer peripheral device to give a switch plate a more cushioned feel. For example, in existing systems gaskets may be positioned between a top frame and switch plate to help dampen vibrations and other impact forces that occur during operation of the peripheral device. Along with providing improved feel for a user, the gaskets may help prevent direct contact and abrasive wear between two rigid components of the peripheral device.

Certain implementations are adapted to co-mold a substrate and a gasket to form a switch plate. By co-molding the substrate and the gasket, fewer parts may be used, manufacturing processes may be more simplistic, vibrations may be further reduced, external elements (e.g., dust, liquid) may be better kept out of the peripheral device, and more precise alignment of the substrate to the gasket may take place, etc.

In certain embodiments, forming a switch plate by co-molding the gasket and the substrate may allow for more unique keyboard designs to be created with different lighting effects. In certain embodiments, the gasket can further be used to form other computer peripheral device components such as keyboard feet, component encasings (e.g., key caps), heat emission regions, sensor interface regions, etc.

It is to be understood that this high level summary is presented to provide the reader with a baseline understanding of some of the novel aspects of the present disclosure and a roadmap to the details that follow. This high level summary in no way limits the scope of the various embodiments described throughout the detailed description and each of the figures referenced above are further described below in greater detail and in their proper scope.

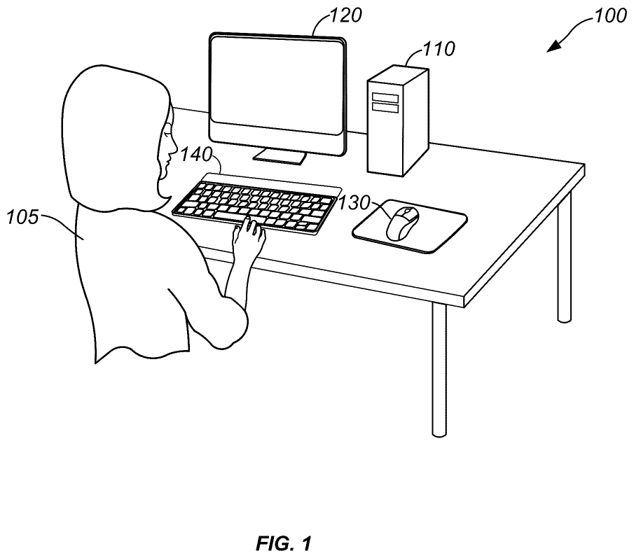

FIG. 1 illustrates an example of a computer system 100 that can include any of a variety of host computing devices and computer peripheral devices, including computer peripheral devices (e.g., a computer mouse, keyboard, etc.) that can be configured to perform aspects of the various inventive concepts described herein. Computer system 100 shows a user 105 operating a host computing device (shown as a desktop computer) 110 and a number of computer peripheral devices that can be coupled to and/or integrated with the host computing device, including a display device 120, a computer mouse 130, a keyboard 140, and may include any other suitable computer peripheral device (e.g., microphone, speaker(s), docking station, headphones, etc.). Each computer peripheral device 120-140 can be communicatively coupled to host computing device 110.

Although the host computing device is shown as a desktop computer, other types of host computing devices can be used including gaming systems, laptop computers, set top boxes, entertainment systems, tablet or “phablet” computers, stand-alone head mounted displays (“HMD”), or any other suitable host computing device (e.g., smart phone, smart wearable, or the like). In some cases, multiple host computing devices may be used and one or more of the computer peripheral devices may be communicatively coupled to one or more of the host computing devices (e.g., a computer mouse may be coupled to multiple host computing devices). A host computing device may also be referred to herein as a “host computer,” “host device,” “computing device,” “computer,” or the like, and may include a machine readable medium (not shown) configured to store computer code, such as driver software, firmware, and the like, where the computer code may be executable by one or more processors of the host computing device(s) to control aspects of the host computing device, for instance via the one or more computer peripheral devices.

A typical computer peripheral device can include any suitable input device, output device or input/output device including those shown (e.g., a computer mouse) and not shown (e.g., remote control, wearables (e.g., gloves, watch, head mounted display), AR/VR controller, CAD controller, joystick, simulation shifter, stylus device, or other suitable device that can be used, for example, to convert analog inputs into digital signals for computer processing. By way of example, a computer peripheral device (e.g., computer mouse 130) can be configured to provide control signals for movement tracking (e.g., x-y movement on a planar surface, three-dimensional “in-air” movements, etc.), touch and/or gesture detection, lift detection, orientation detection (e.g., in 3 degrees-of-freedom (DOF) system, 6 DOF systems, etc.), power management capabilities, input detection (e.g., buttons, scroll wheels, etc.), output functions (e.g., LED control, haptic feedback, etc.), or any of myriad other features that can be provided by a computer peripheral device, as would be appreciated by one of ordinary skill in the art. The buttons of computer mouse 130 and the keys of keyboard 140 (or other depressible element on any input device) may incorporate hybrid switch architectures, as presented herein.

An input device may be a computer peripheral device, and may be referred to as either herein, as well as a “peripheral input device,” “peripheral,” or the like. The majority of the embodiments described herein generally refer to computer peripheral device 140, however it should be understood that a computer peripheral device can be any suitable input/output (I/O) device (e.g., user interface device, control device, input unit, or the like) that may be adapted to utilize the novel embodiments described and contemplated herein.

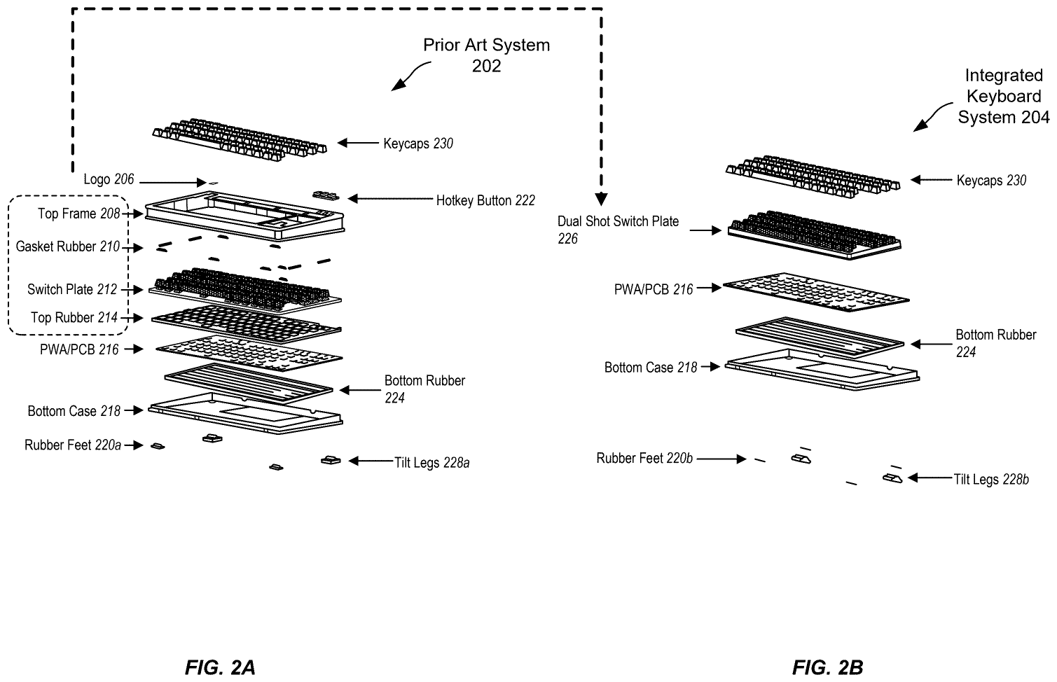

FIGS. 2A-2B show simplified exploded views of keyboard systems. Specifically, FIG. 2A illustrates a prior art system 202 and FIG. 2B illustrates an embodiment of the integrated keyboard system 204.

FIG. 2A may include keycaps 230, a logo 206, a hotkey button, a top frame 208, gasket rubber 210, a switch plate 212, top rubber 214, a printed circuit board (PCB) 216, a bottom rubber 224, a bottom case 218, rubber feet 220a, and/or tilt legs 228a.

Prior art system 202 may be a keyboard system that is similar to traditional keyboard systems.

The tilt legs 228a may be coupled with the bottom case 218. The tilt legs 228a may be capable of changing position so that the tilt of the tilt legs 228a can be adjusted. The tilt legs 228a may allow for the bottom case 218 to be raised off of a surface (e.g., table) at varying degrees or for the bottom case 218 to lie flush with the surface. The tilt legs 228a may be commonly made from plastic.

The rubber feet 220a may be coupled to the bottom case 218 and/or tilt legs 228a. The rubber feet 220a may be capable of raising the bottom case 218 off of a surface (e.g., table). The rubber feet 220a may also help reduce the noise generated between the contact of the bottom case 218 the surface during input (e.g., during typing by a user, during clicking by a user).

The bottom case 218 may be commonly made from plastic but may also be made of other materials such as metal or wood. The bottom case 218 may be capable of housing other components (e.g., battery) of the prior art system. The bottom case 218 may prevent dust and liquids from coming in contact with components in the prior art system and housed between the bottom case 218 and top frame 208. The bottom case 218 may be coupled with the bottom rubber 224 and/or in contact with the bottom rubber 224. An upper surface of the bottom case 218 may be in contact with and/or coupled with a lower surface of the bottom rubber 224.

The bottom rubber 224 may be capable of reducing noise from prior art system components during input (e.g., typing). The bottom rubber 224 may further be capable of reducing the intensity of vibrations that travel from prior art system components to the bottom case 218, and/or vice versa. The bottom rubber 224 may be coupled with and/or in contact with the PCB 216. For example, the bottom rubber 224 may be positioned between the bottom case 218 and the PCB 216 to help prevent and/or limit direct contact between the bottom case 218 and the PCB 216. This may enable the bottom rubber 224 to dampen vibrations and other forces transmitted from the PCB 216 to the bottom case 218, such as forces from a user manipulating buttons or other input mechanisms of the prior art system 202.

The PCB 216 may be coupled with and/or in contact with the top rubber 214. The PCB 216 may also be referred to as a printed wiring assembly (PWA). The PCB 216 may include electronics and circuitry that allow the prior art system to receive and transmit signals and inputs. The PCB 216 may be coupled with switches, which may be mounted on the switch plate 212. The PCB 216 may be capable of producing signals based on an activation of a switch when the corresponding keycap for the switch is manipulated. In certain embodiments, the PCB 216 may be sized to interface with any number of keycaps 230. Conductive pathways between components of the PCB 216 may be provided by the PCB 216. The PCB 216 may provide for mounting points of components, such as mounting points for controllers, lights, etc. The PCB 216 may serve as a circuit that connects all the key switches and other electronic components, allowing them to be communicatively coupled with a computing device.

An electrical circuit of the PCB 216 may be closed when a switch is manipulated. The PCB 216 may be connected to a microcontroller. The microcontroller may process signals from the switches and may convert interactions with the switches to digital signals that the computing device can receive and use. The microcontroller may process signals from the switches and may convert interactions with the switches into digital signals that other components of the prior art system can use (e.g., adjust lighting, adjust profile). The microcontroller may receive and process signals from the computing device and be caused to adjust settings (e.g., profile, lighting, of an integrated display). The PCB 216 may be connected to the computing device via a wired (e.g., USB) and/or wireless connection (e.g., Bluetooth).

The PCB 216 may include electrical components used by the prior art system to receive input (e.g., from a user) and transmit a signal to a computing device. The PCB 216 may also receive input (e.g., from a user, from a computing device, from an environment) and be configured (e.g., change lighting, change profile, etc.) based on the input.

The top rubber 214 may be coupled with and/or in contact with the PCB 216. In certain embodiments, an upper surface of the PCB 216 is in contact with a lower surface of the top rubber. The top rubber 214 may be coupled with and/or in contact with the switch plate 212. In certain embodiments, an upper surface of the top rubber 214 is in contact with a lower surface of the switch plate 212. The top rubber 214 may be made of one or more materials. The one or more materials may be resilient material (e.g., rubber) or acoustic dampening material (e.g., rubber, foam, etc.). Since the top rubber 214 may be positioned between the PCB 216 and the switch plate 212, the resilient material of the top rubber 214 may be capable of reducing the amount and/or intensity of vibrations that travel from prior art system 202 components, such as the switch plate 212, to the PCB 216, and/or vice versa. The top rubber 214 may reduce the amount of sound produced by manipulating the keycaps 230 of the prior art system 202 by acting as a cushion between the PCB 216 and the switch plate 212 and thereby reducing the pressure transferred to other components of the prior art system 202 (e.g., the bottom case 218, rubber feet 220a). Similar to the bottom rubber 224, the top rubber 214 may be positioned to help prevent and/or limit direct contact between prior art system 202 components. For example, the top rubber 214 may be positioned between the PCB 216 and the switch plate 212 to help prevent and/or limit direct contact between the switch plate 212 and the PCB 216. This may enable the top rubber 214 to dampen vibrations and other forces transmitted from the switch plate 212 to the PCB 216, such as forces from a user manipulating buttons or other input mechanisms of the prior art system 202.

The switch plate 212 may be coupled with the top rubber 214. The upper surface of the switch plate 212 may be coupled with and/or in contact with a lower surface of the gasket rubber 210 and/or the lower surface of the top frame 208. The lower surface of the switch plate 212 may be in contact with and/or coupled with the upper surface of the top rubber 214. The switch plate 212 may be rigid and may provide a mounting site for key switches and/or other components of system 202. The switch plate 212 may define apertures that each receive one or more switches (e.g., key switches) and allow the switches to pass through so that when a respective switch is interacted with/manipulated (e.g., pressed), a corresponding circuit is closed on the PCB 216 and the interaction is detected by the PCB 216. The switch plate 212 may provide stability to switches and help ensure that there is a consistent key feel and performance across the keyboard. The switch plate 212 may typically be made from aluminum, steel, or plastic. The switch plate 212 may be coupled with and/or in contact with the gasket rubber 210.

The gasket rubber 210 may act as a dampening mechanism. The gasket rubber 210 may dampen the impact force and vibrations transferred to other system components from the switches. The gasket rubber 210 may be placed between the switch plate 212 and the top frame 208. The upper surface of the gasket rubber 210 may be coupled with and/or in contact with the lower surface of the top frame 208. The lower surface of the gasket rubber 210 may be coupled with and/or in contact with the upper surface of the switch plate 212. The gasket rubber 210 may be coupled to and/or in contact with the top frame 208. The gasket may be made of silicon, rubber, and/or other resilient material. The gasket rubber 210 may reduce the noise caused by keystrokes of the switches.

The top frame 208 may be coupled with and/or in contact with the gasket rubber 210. A lower surface of the top frame 208 may be coupled with and/or in contact with an upper surface of the gasket rubber 210. The top frame 208 may be coupled with the bottom case 218 to enclose components of the system (e.g., the gasket rubber 210, the switch plate 212, the top rubber 214, the PCB 216, the bottom rubber 224). The top frame 208 may be made of plastic or metal. The top frame 208 may be capable of preventing liquid and dust from entering the system enclosed by the top frame 208 and the bottom case 218. The top frame 208 may have a logo 206 printed on it or coupled to it.

The prior art system may also include keycaps 230 that are coupled to switches. The keycaps 230 may be user recognizable as corresponding to predetermined input. For example, the keycap may have a specific character (e.g., letter, number, symbol, etc.) printed on it and be representative of an input signal that would be sent to a computing device when the keycap is manipulated, thereby causing the corresponding switch to be interacted with. The keycaps 230 may be removably coupled to switches.

The prior art system may further include hotkey buttons. The hotkey buttons may be similar to the keycaps 230. The hotkey buttons may correspond to switches of the switch plate 212. The hotkey buttons may be a switch plate 212 that is integrated with a keycap.

FIG. 2B illustrates a simplified example of an integrated keyboard system 204, according to certain embodiments. The integrated keyboard system 204 may include keycaps 230, a dual shot switch plate 226, a PCB 216, a bottom rubber 224, a bottom case 218, rubber feet 220b, and/or tilt legs 228b.

The rubber feet 220b, tilt legs 228b, bottom case 218, bottom rubber 224, PCB 216, and keycaps 230 may function in a similar fashion to those components described with respect to FIG. 2A and may include any feature as described above.

As illustrated, embodiments of the present invention may be capable of integrating the top frame 208, the gasket rubber 210, the switch plate 212, and/or the top rubber 214 into a single component, the dual shot switch plate 226. The dual shot switch plate 226 can be coupled with and/or in contact with the PCB 216. A lower surface of the dual shot switch plate 226 may be in contact with and/or coupled with an upper surface of the PCB 216. In certain embodiments, the dual shot switch plate 226 includes a rigid material (e.g., a rigid polymeric material) that provides structure for supporting key switches and/or other components and a gasket that dampens forces applied to keys and/or other components to reduce noise and create a softer user experience. The gasket may comprise a resilient polymeric material. The dual shot switch plate 226 may be the top most structural component of the integrated keyboard system 204. Since the dual shot switch plate 226 may be placed above the PCB 216 and other components, pressure and/or vibrations transferred from the manipulations to the keycaps and/or dual shot switch plate 226 may be reduced before reaching the PCB 216 and other integrated keyboard system 204 components because of the gasket included in the dual shot switch plate 226.

The dual shot switch plate 226 may be capable of serving as the top frame 208, the gasket rubber 210, the switch plate 212, and/or the top rubber 214. Thus, the dual shot switch plate 226 is capable of reducing the number of components compared to the prior art system 202. The reduced component count may reduce the materials needed to manufacture the integrated keyboard system 204 compared to the prior art system 202. Thus, the energy to produce the integrated keyboard system 204 may be reduced compared to the prior art system 202. Further, the energy may be reduced to manufacture the integrated keyboard system 204 compared to the prior art system 202 because the time to manufacture the integrated keyboard system 204 may be less than the prior art system 202. The reduced component count may reduce the cost, time, complexity, and material required to manufacture the peripheral device (or integrated keyboard system 204).

The dual shot switch plate 226 may be capable of allowing for further customization to be made to the manufacturing process of the peripheral device. The dual shot switch plate 226 may further improve the feel of the peripheral device. For example, the dual shot switch plate 226 may be capable of reducing the amount of vibrations that are caused by inputs to keycaps 230 of the peripheral device. For example, the gasket of the dual shot switch plate 226 may help prevent and/or limit direct contact between the substrate of the dual shot switch plate 226 the PCB 216. In an example, the gasket of the dual shot switch plate 226 may help prevent and/or limit direct contact between the keycaps 230 and the PCB 216. The prevention and/or limitation of direct component contact may enable the gasket of the dual shot switch plate 226 to dampen vibrations and other forces transmitted from the dual shot switch plate 226 (e.g., the substrate of the dual shot switch plate 226) and/or keycaps to the PCB 216, such as forces from a user manipulating buttons or other input mechanisms of the integrated keyboard system 204. The gasket of the dual shot switch plate 226 may include resilient and/or acoustic dampening material capable of reducing the pressure and sound transferable through the gasket of the dual shot switch plate 226.

The dual shot switch plate 226 may better absorb the force of a drop of the peripheral device and therefore better protect components of the integrated keyboard system 204. For example, the gasket of the dual shot switch plate 226 may reduce the force transferred to components of the integrated keyboard system 204 (e.g., the PCB 216) from the dual shot switch plate 226. In certain embodiments, the gasket is externally exposed from the integrated keyboard system 204 and therefore may directly absorb pressure (e.g., during a drop). In certain embodiments, the gasket is enclosed by the integrated keyboard system 204 and therefore may indirectly absorb pressure (e.g., during a drop) after the force has been transferred from the substrate of the dual shot switch plate 226 to the gasket of the dual shot switch plate 226 and before the force is transferred to other components (e.g., the PCB 216) of the integrated keyboard system 204.

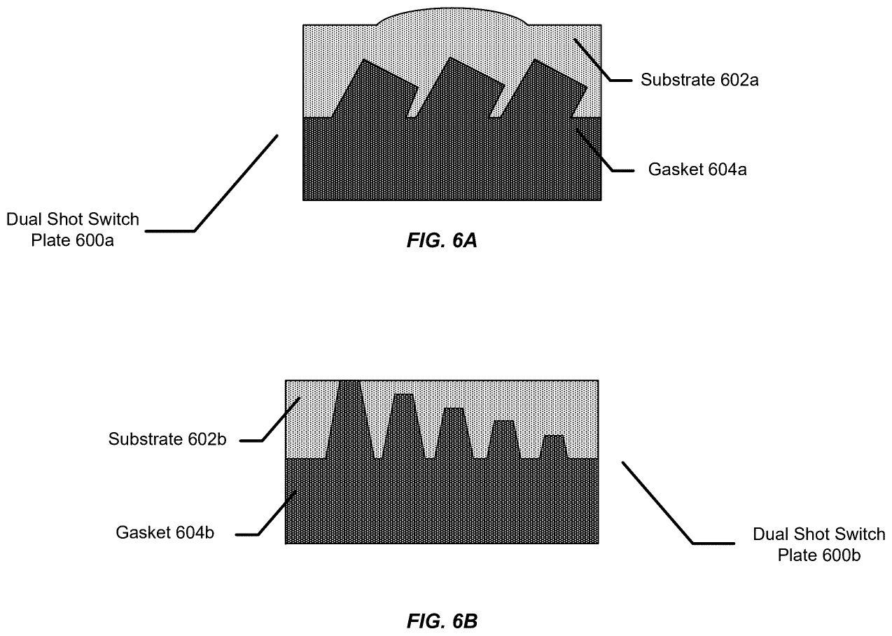

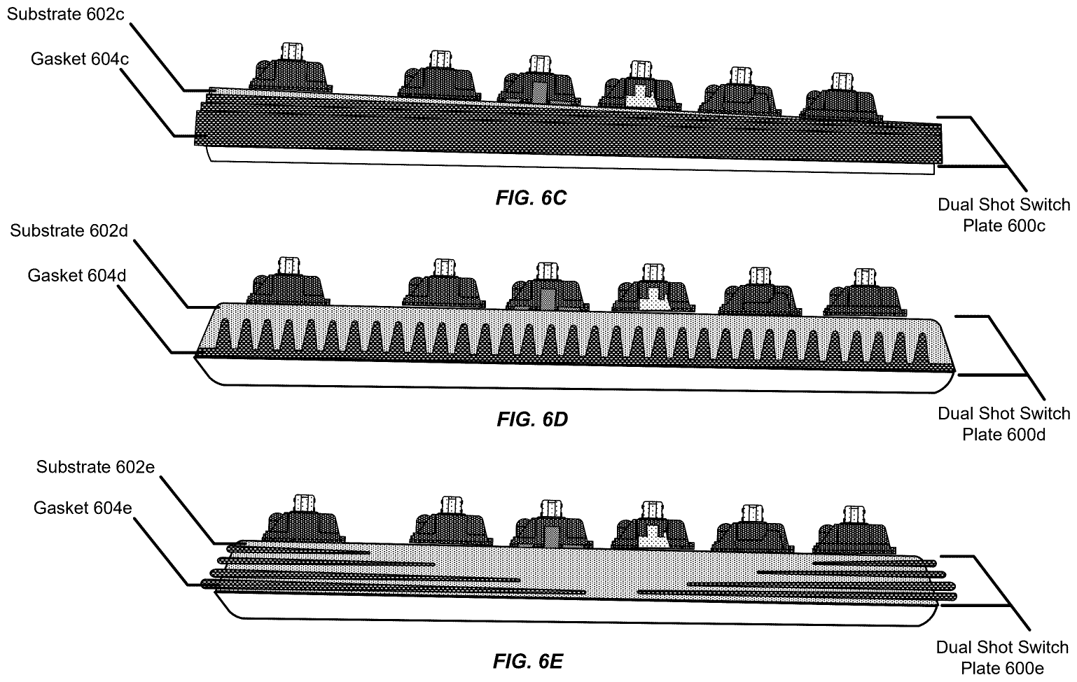

The dual shot switch plate 226 may be capable of allowing light to transmit and refract (e.g., in a different manner than traditional methods). Further, the dual shot switch plate 226 may be capable of allowing light to transmit and refract through the dual shot switch plate 226 differently in different portions of the dual shot switch plate 226 compared to other portions of the same dual shot switch plate 226. The light transmission capabilities of the dual shot switch plate are described in more detail below (e.g., FIG. 6).

In certain embodiments, the dual shot switch plate 226 may further provide feet, legs, and/or the bottom case 218 of the integrated keyboard system 204. Further embodiments are discussed herein below.

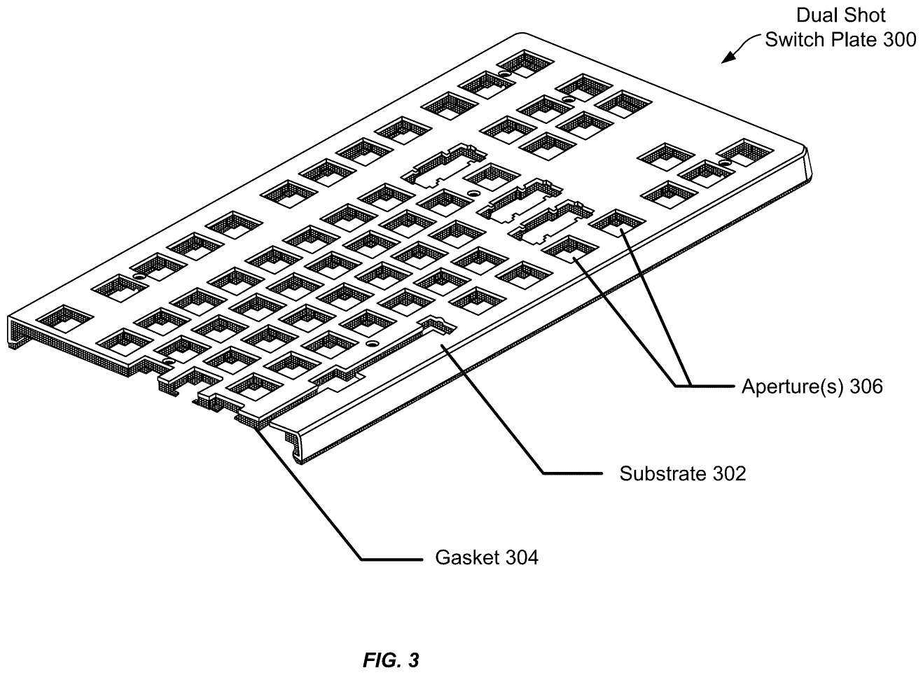

FIG. 3 illustrates a simplified diagram of a dual shot switch plate 300, according to certain embodiments. Dual shot switch plate 300 may be similar to dual shot switch plate 226 and may include any features described in relation to dual shot switch plate 226.

The dual shot switch plate 300 may be included in a computer peripheral device (e.g., keyboard), including being used as dual shot switch plate 226 in integrated keyboard system 204. The dual shot switch plate 300 may include a rigid substrate 302 and a resilient gasket 304. The substrate 302 may be configured to protect components of the computer peripheral device. For example, the rigid surface of the substrate 302 may protect force applied to the substrate 302 from bending the substrate 302 and/or components lying beneath the substrate 302 and that may be internal to the computer peripheral device. The substrate 302 may prevent dust, liquids, etc. from coming in contact with the gasket 304 and/or other materials below the lower surface of the substrate 302.

The substrate 302 may be made of a material that is capable of bonding with the gasket 304. The gasket 304 material may be bonded with the substrate 302 in a manner that does not use an adhesive. The substrate 302 material may be characterized by a melting temperature that is higher than the melting temperature of the material of the gasket 304 so that when the gasket 304 material is molded with the substrate 302 material, the substrate 302 material keeps its shape.

The gasket 304 may include resilient material (e.g., TPE) so that when keys of the computer peripheral device are manipulated, a softer feel is provided to a user of the computer peripheral device. The gasket 304 may keep the substrate 302 from coming into direct contact with other components (e.g., the PCB) so that when components (e.g., keys) of the computer peripheral device are manipulated, sound produced is reduced and/or so that force transferred from the substrate 302 to the PCB or other components is reduced.

The co-molded (e.g., using a two-shot injection molding process, insert molding, overmolding, etc.) substrate 302 and gasket 304 may form the dual shot switch plate 300 capable of replacing multiple components of prior art systems. The dual shot switch plate 300 may have a thickness of about 5 millimeters, less than 10 millimeters, less than 7.5 millimeters, less than 2.5 millimeters, etc. In certain embodiments, the thickness of the dual shot switch plate 300 may be greater than or less than 5 millimeters and may be based on material cost, product design weight goals, durability design goals, noise reduction design goals, user feel design goals, etc.

The substrate 302 may have an upper surface and a lower surface. The substrate 302 may be made of a rigid polymeric material. In certain embodiments, the substrate 302 may include at least one of plastic, metal, aluminum, wood, etc. The substrate 302 may be of a uniform thickness or varying thickness. In certain embodiments, the lower surface of the substrate 302 may be substantially flat. In certain embodiments, the upper surface of the substrate 302 may be substantially flat or may be formed to have raised and/or sunken portions. The raised and/or sunken portions may have the same or different heights and/or depths, respectively. In certain embodiments, the height and/or depth may vary or may be consistent across the respective surface of the substrate 302. In certain embodiments, the thickness of the substrate 302 is around 2.5 millimeters, less than 7.5 millimeters, less than 2.5 millimeters, around 5 millimeters, etc. In certain embodiments, the substrate 302 is thinner than 2.5 millimeters to reduce weight of the dual shot switch plate 300, reduce material use, etc. In certain embodiments, the substrate 302 is thicker than 2.5 millimeters so that the substrate 302 is better able to withstand forces (e.g., bending, punctures).

The gasket 304 may have an upper surface and a lower surface. The gasket 304 may be made of a resilient polymeric material (e.g., thermoplastic elastomers (TPE), plasticized copolyamide thermoplastic elastomers (PCTPE), etc.). The gasket can be made of foam and/or sponge, etc. The gasket 304 may be of a uniform thickness or varying thickness. In certain embodiments, the gasket 304 may have a thickness of about 2.5 millimeters. In certain embodiments, the gasket 304 is thinner than 2.5 millimeters to reduce weight of the dual shot switch plate 300, reduce material use, etc. In certain embodiments, the gasket 304 is thicker than 2.5 millimeters so that the gasket 304 is better able to withstand forces applied to the gasket by the substrate 302, directly by a user, by a surrounding (e.g., table surface), or another system component. In certain embodiments, the gasket 304 is configured to have a greater thickness so that a more cushioned feel is provided to a user when keys or other components of the computer peripheral device are manipulated by the user. In certain embodiments, the more cushioned feel may be achieved by using a gasket 304 material that is characterized by a softer hardness (e.g., durometer shore hardness scale). The hardness of the gasket 304 material may be between 60-80 shore A. The hardness of the gasket 304 may be harder/stiffer with a 90 shore A value.

In certain embodiments, the method of manufacturing may enable a harder and/or softer material to be used for the gasket 304. For example, using an insert molding manufacturing process for the dual shot switch plate 300, the gasket 304 may be capable of including softer material (e.g., foam, sponge) than compared to when a double-injection manufacturing process is used. The method of manufacturer used for the dual shot switch plate 300 may be capable of being cheaper, faster, more precise, etc. compared to other possible methods of manufacture. For example, a two-shot injection molding process may be cheaper (e.g., because less energy is used, faster cycle time, less material is used) than an overmolding process and/or an adhesive process. The flexibility and/or precision of the dual shot switch plate 300 may also be affected by manufacturing process used.

In certain embodiments, the upper surface of the gasket 304 may be substantially flat. In certain embodiments, the lower surface of the substrate 302 may be substantially flat or may be formed to have raised and/or sunken portions. The raised and/or sunken portions may have the same or different heights and/or depths, respectively. In certain embodiments, the height and/or depth is or is not consistent across the respective surface of the substrate 302. In certain embodiments, a thickness of a substantial portion of the gasket 304 is between 1.5 mm and 3.5 mm.

The gasket 304 may be coupled with a surface of the substrate 302. In certain embodiments, the gasket 304 may be coupled with the substrate 302. In certain embodiments, the gasket 304 is coupled with the lower surface of the substrate 302. In certain embodiments, the upper surface of the gasket 304 may be coupled with the lower surface of the substrate 302. The gasket 304 and the substrate 302 may be co-molded. The interface between the substrate 302 and the gasket 304 may be substantially adhesive free. For example, less than 20% of the interface (e.g., surface area) between the substrate 302 and the gasket 304 may be bonded using an adhesive. In certain embodiments, between 0-5% of the interface between the substrate 302 and the gasket 304 may be bonded using an adhesive. Co-molding the gasket 304 and the substrate 302 may allow for cost to be reduced because no adhesives may be used.

Further, using co-molding may provide for better ability to repeatedly create components with the same structural features and quality. Co-molding the substrate 302 and the gasket 304 may also allow for more precise shapes and thicknesses to be used as opposed to creating the substrate 302 and gasket 304 before joining them with an adhesive. Co-molding the substrate 302 and the gasket 304 can have an improved precision (e.g., alignment precision), more flexible structure, and enable more efficient mass production (e.g., less materials used, faster production time, etc.) compared to using an adhesive. Co-molding the substrate 302 and the gasket 304 can enable designs to be more intricate with more size differences, thickness differences, more complex patterns, sharper angles, etc. compared to using an adhesive.

The substrate 302 and/or the gasket 304 may define a set of one or more apertures 306 through a thickness of the dual shot switch plate 300. In certain embodiments, the substrate 302 defines an aperture 306. The aperture 306 may be a button aperture. For example, the substrate 302 may include an opening that a button, switch (such as a key switch), or other component may extend partially (through a portion of the thickness of the aperture 306) or fully through (e.g., through the full thickness of the aperture 306 and protrude above an upper surface of the substrate).

In certain embodiments, the gasket 304 extends through the portion of the aperture 306 that is formed in the substrate 302. The gasket 304 may protrude above an upper surface of the substrate 302. In certain embodiments where the gasket 304 protrudes above an upper surface of the substrate 302, the gasket 304 protrudes above the upper surface for visual appeal, to provide an area of support for a component (e.g., stylus) or hand of a user, etc. The portion of the gasket 304 that protrudes above the upper surface may act as a cushion for the dual shot switch plate 300 and protect the dual shot switch plate 300 or the system it is a part of (e.g., computer peripheral device) from drops or other forces. The portion of the gasket 304 that protrudes above the upper surface of the substrate 302 may provide a more cushioned feel for key presses and/or may enable the dual shot switch plate 300 to have an increased flexibility compared to not having a gasket 304 that protrudes above the upper surface of the substrate 302.

One or more apertures 306 of the set of apertures 306 may be key apertures. For example, a key aperture may allow for a switch coupled to a PCB to pass through the dual shot switch plate 300 and/or allow for a key cap to be coupled to the switch so that when the switch is activated (e.g., pressed, moved), the PCB may receive an indication of the activation. In certain embodiments, the one or more apertures 306 of the set of apertures may be configured to allow one or more components of the PCB and/or coupled with the PCB to pass through the dual shot switch plate 300 (e.g., a light emitting diode (LED)). In certain embodiments, the one or more apertures 306 of the set of apertures may be configured to allow one or more components of the PCB and/or coupled with the PCB to be visually exposed from the upper surface of the dual shot switch plate 300 (e.g., an LED on the PCB located opposite the upper surface of the substrate 302 may be viewed from the upper surface side of the substrate 302).

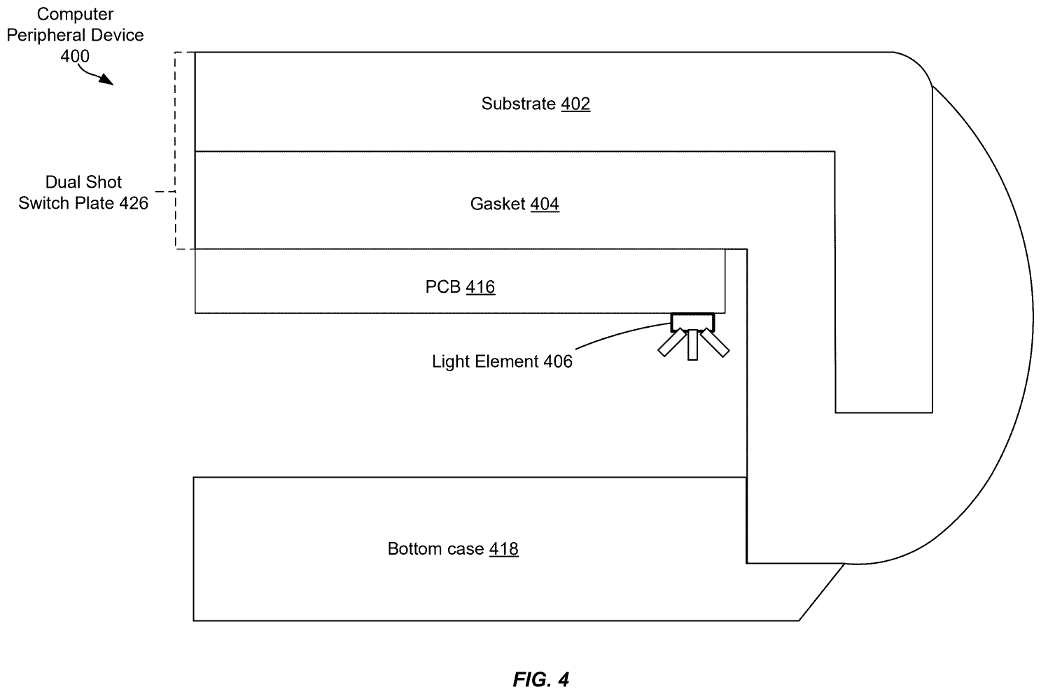

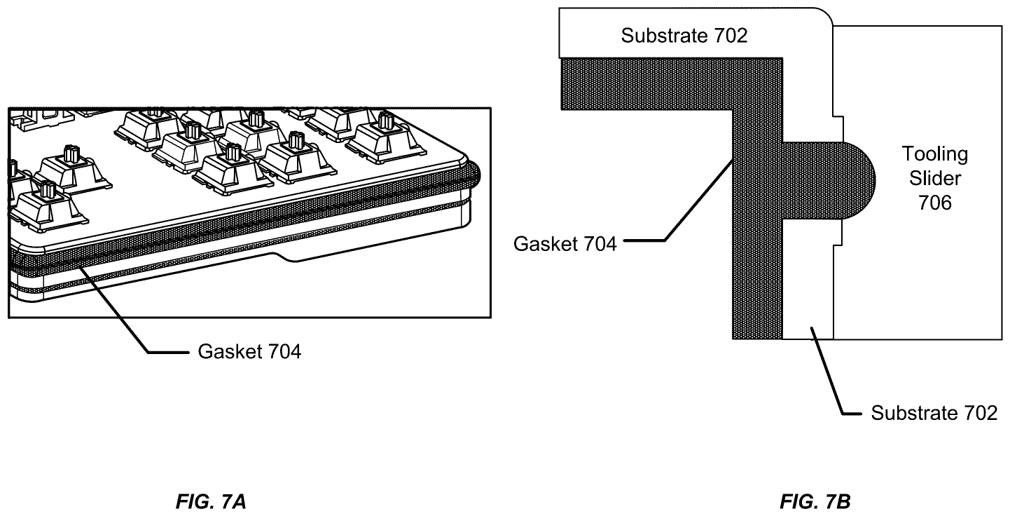

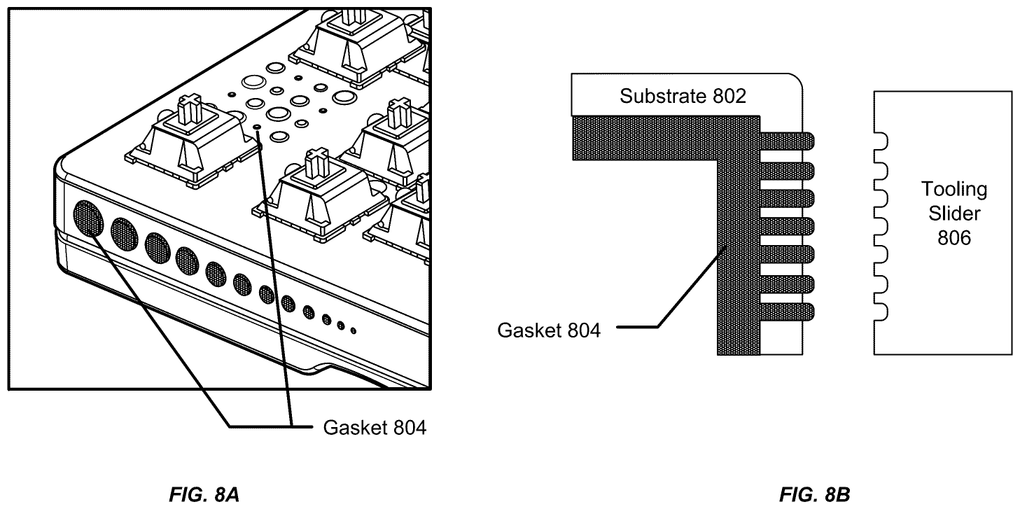

In certain embodiments, at least a portion of the gasket 304 may extend laterally outward beyond a peripheral surface of the substrate 302 that includes at least one aperture 306. For example, at least a portion of the gasket 304 may extend through the peripheral of the substrate 302 (e.g., FIGS. 7 and 8). As a further example, at least a portion of the gasket 304 may extend past the peripheral surface of the substrate 302 (e.g., FIG. 4). In certain embodiments, the gasket 304 may wrap around the substrate 302 and be in contact with one or more portions of the substrate (e.g., lateral sides). In certain embodiments, the gasket may extend past the substrate 302 in the same plane as the substrate 302.

FIG. 4 illustrates a cross section of an example simplified diagram of a computer peripheral device 400, according to certain embodiments. The computer peripheral device may include a dual shot switch plate 426, a PCB 416, light element 404, and a bottom case 418. The dual shot switch plate 426 may be similar to dual shot switch plate 300 and may include any features described in relation to dual shot switch plate 300. The bottom case 418 may be similar to the bottom case 218 described above and may include any features described in relation to substrate 402.

The dual shot switch plate 426 may include a substrate 402 and a gasket 404. The substrate 402 may be similar to the substrate 302 described above and may include any features described in relation to substrate 302. The gasket 404 may be similar to the gasket 304 described above and may include any features described in relation to gasket 304. The dual shot switch plate 426 may form the topmost structural component of the computer peripheral device (e.g., keyboard).

At least a portion of the gasket 404 may be disposed above the PCB 416. At least a portion of the gasket 404 may be disposed between a lower surface of one or more switches of a set of key switches and an upper surface of the PCB 416. As described above, the gasket 404 of the dual shot switch plate 426 may help prevent and/or limit direct contact between the substrate 402 of the dual shot switch plate 426 the PCB 416. In an example, the gasket 404 of the dual shot switch plate 426 may help prevent and/or limit direct contact between keycaps and the PCB 416. The prevention and/or limitation of direct component contact may enable the gasket 404 of the dual shot switch plate 426 to dampen vibrations and other forces transmitted from the dual shot switch plate 426 (e.g., the substrate 402 of the dual shot switch plate 426) and/or keycaps to the PCB 416, such as forces from a user manipulating buttons or other input mechanisms of the computer peripheral device 400. The gasket 404 of the dual shot switch plate 426 may include resilient and/or acoustic dampening material capable of reducing the pressure and sound transferable through the gasket 404 of the dual shot switch plate 426.

The PCB 416 may have an upper surface and a lower surface. In certain embodiments, the computer peripheral device includes more than one PCB 416. Each PCB 416 may be disposed below the dual shot switch plate 426 surface (e.g., against the lower surface of the dual shot switch plate 426 surface and/or otherwise beneath the dual shot switch plate 426). In certain embodiments, the PCB 416 may be disposed below the dual shot switch plate 426. As already described above, the PCB 416 may include and/or be coupled with a set (e.g., one or more) of switches (e.g., key switches). In certain embodiments, one or more key switches extend through a respective key aperture formed through the dual shot switch plate 426. In certain embodiments, each of the set of switches extends through a respective one of the set of apertures (e.g., key apertures).

The light element 406 may be coupled to the PCB 416. In certain embodiments, zero or more light elements 406 are coupled to the PCB 416. In certain embodiments, each lighting element from a set of lighting elements is coupled to a respective portion of the PCB 416. In certain embodiments, at least one lighting element is on a different surface or side of the PCB 416 than another lighting element. Each lighting element 406 may be an LED lighting element. In certain embodiments, at least one light element 406 may be disposed below the PCB 416.

The bottom case 418 may have an upper surface and a lower surface. The bottom case 418 may be made of a rigid polymeric material. In certain embodiments, the bottom case 418 may include at least one of plastic, metal, aluminum, wood, etc. The bottom case 418 may be of a uniform thickness or varying thickness. In certain embodiments, the lower surface of the bottom case 418 may be substantially flat (e.g., flat with a tolerance of plus or minus 0.5 cm) or may be formed to have raised and/or sunken portions. In certain embodiments, the upper surface of the bottom case 418 may be substantially flat or may be formed to have raised and/or sunken portions. The raised and/or sunken portions may have the same or different heights and/or depths, respectively. In certain embodiments, the height and/or depth is or is not consistent across the respective surface of the bottom case 418. In certain embodiments, the substrate 402 and the bottom case 418 are the same material and/or piece of material.

At least a portion of the gasket 404 may be disposed above an upper surface of the bottom case 418. At least a portion of the gasket 404 may be disposed between a lower surface of one or more switches of a set of key switches and the upper surface of the bottom case 418.

The bottom case 418 may be coupled and/or be in contact with the dual shot switch plate 426 and/or PCB 416. The bottom case 418 may support the PCB 416 and/or the dual shot switch plate 426. In certain embodiments, the gasket 404 may be coupled with at least one surface of the bottom case 418. In certain embodiments, at least a portion of the gasket 404 is present between the substrate 402 and the bottom case 418 at substantially all contact interfaces (e.g., more than 90% of the contact interfaces) between the dual shot switch plate 426 and the bottom case 418. The placement between the substrate 402 and the bottom case 418 may prevent vibration transferred from the dual shot switch plate 426 to the bottom case 418 and thereby reduce sound vibrations transferred from the bottom case 418 to a surface (e.g., table) the bottom case 418 is in contact with. The placement may reduce the sound of using the computer peripheral device 400 because of the absorption of force and sounds between manipulation keys and the force exerted on the bottom case 418 caused by the manipulation of keys, other forces exerted on the computer peripheral device 400 or dual shot switch plate 426.

Some embodiments include fewer or additional components than the depicted computer peripheral device. For example, in certain embodiments, a bottom rubber cushion is disposed between the PCB 416 and the bottom case 418.

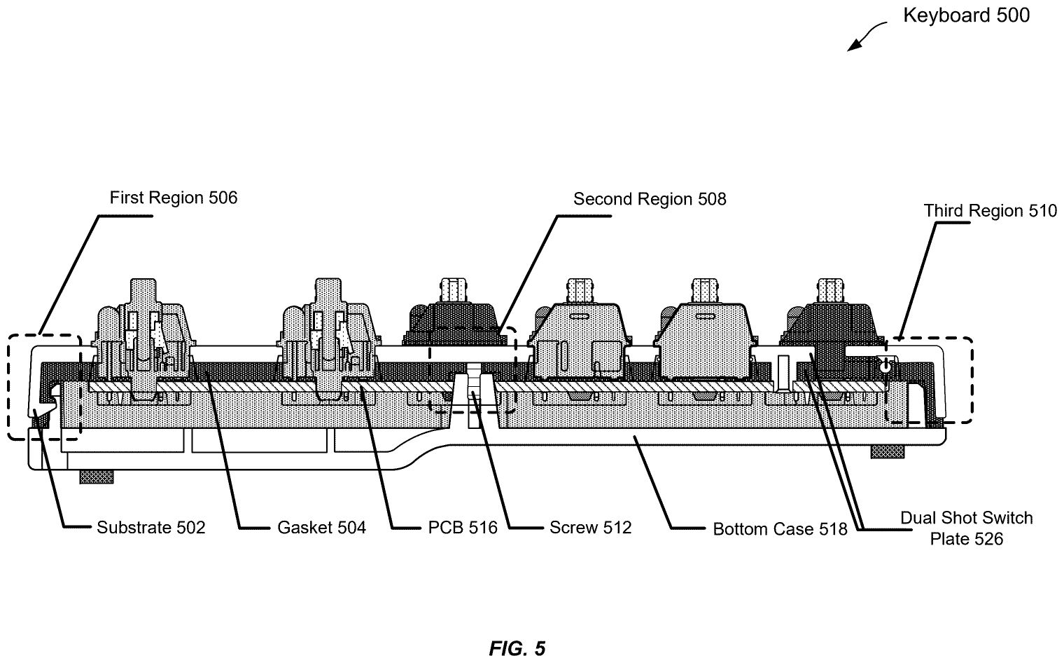

FIG. 5 illustrates a cross section of an example simplified diagram of a keyboard 500, according to certain embodiments.

The illustrated keyboard 500 includes a first region 506, a second region 508, a third region 510, a substrate 502, a gasket 504, a PCB 516, a screw 512, a dual shot switch plate 526, and a bottom case 518. Each of the substrate 502, gasket 504, PCB 516, dual shot switch plate 526, and bottom case 518 may be similar to the substrate 402, gasket 404, PCB 416, dual shot switch plate 426, and bottom case 418, respectively described above and may include any features described in relation to substrate 502, gasket 504, PCB 516, dual shot switch plate 526, and bottom case 518 may be similar to the substrate 402, gasket 404, PCB 416, dual shot switch plate 426, and bottom case 418, respectively.

As mentioned above, the substrate 502 and gasket 504 may comprise a dual shot switch plate 526. The first region 506 and the third region 510 illustrate that the substrate 502 and the gasket 504 may be co-molded in various configurations.

For example, in the first region 506, the gasket 504 may be co-molded to wrap around at least a portion of the surface of the substrate 502. This may provide support for the substrate 502, may increase the structural integrity of the dual shot switch plate 526, provide for a different visual appearance of the peripheral device (e.g., keyboard 500), give the dual shot switch plate 526 a more cushioned feel to a user, and/or help prevent the substrate 502 from coming in contact with a component other than the gasket 504.

In an example, in the third region 510, the gasket 504 may be co-molded with the substrate 502 and may extend past the substrate 502. Such a design may provide for a different feel to a user than the first region 506, may reduce the substrate 502 material used compared to the first region 506, may cause the peripheral device (e.g., keyboard 500) to have a different visual appearance, and/or may allow a substrate 502 with a more simplistic shape to be formed. A substrate 502 with a more simplistic shape may be stronger, may use less material, and/or may be faster to produce.

In certain embodiments, the substrate 502 is a complex shape with varying dimensions. The complex shape may offer increased support at certain regions. The complex shape may have a unique visual appearance. The complex shape may act as a fastening mechanism to fasten the dual shot switch plate 5226 to one or more components of the computer peripheral device, such as to the bottom case 518 and/or PCB 516. The gasket 504 may be co-molded with the substrate 502 so that the gasket 504 is in contact with one or more surfaces of substrate 502. As mentioned above, the substrate 502 and/or gasket 504 may be co-molded in a fashion where the substrate 502 and/or gasket 504 are characterized by different thicknesses at one or more positions.

In certain embodiments, the dual shot switch plate 526 and the bottom case 518 are secured together using a set of limited height screws (e.g., screw 512) that limit a default level of compression of the gasket 504. The second region 506 illustrates how the gasket 504 may be configured so that one or more screws 512 (e.g., limited height screws 512 to avoid excessive screw compression of the gasket 504, substrate 502, and/or other components in contact with the dual shot switch plate) may extend at least partially through the thickness of the gasket 504.

In certain embodiments, one or more screws 512 may extend through the gasket 504 and the substrate 502. One or more screws 512, clips, nails, or other coupling component extending through the gasket 504 and/or the substrate 502 may couple the dual shot switch plate 526 to the PCB 516 and/or bottom case 518. One or more screws 512, clips, nails, or other stabilization component extending through the gasket 504 and/or the substrate 502 may stabilize the dual shot switch plate 526 with respect to the PCB 516 and/or bottom case 518.

FIGS. 6A-E illustrates cross sections of example dual shot switch plates 600, according to certain embodiments.

The dual shot switch plates 600 may include a gasket 604 and a substrate 602. The dual shot switch plate 600, gasket 604, and/or substrate 602 may be configured according to embodiments already described above and may include any features described in relation to any of the above-described embodiments (e.g., dual shot switch plate 526, substrate 502, gasket 504).

The substrate 602 and/or gasket 604 material may allow for light transmission to occur through the substrate 602 and/or gasket 604. The gasket 604 and/or substrate 602 may include at least one of translucent materials or transparent materials. In certain embodiments, the dual shot switch plate 600 may include one or more light transmission regions that enable light emitted beneath the dual shot switch plate 600 to be viewed above and/or through the dual shot switch plate 600. In certain embodiments, a light transmission region includes one or both of translucent materials and transparent materials. The light may be light from one or more components located on a side (e.g., a bottom side) of the dual shot switch plate 600. In certain embodiments, the light transmission region includes a portion of the gasket 604 extending to an upper surface of the substrate 602. In certain embodiments, the light transmission region includes a set of upward extending gasket 604 protrusions (e.g., FIGS. 6A and 6B). At least one light emitting element may be disposed beneath the light transmission region.

In certain embodiments, the PCB includes or is coupled to one or more light emitting elements (e.g., LEDs) that may transmit light through the substrate 602 and/or gasket 604. For example, keyboard may include LEDs on the PCB board so that keys may be backlit for increased user visibility. In an example, a keyboard, number pad, or mouse may include LEDs of various colors for lighting effects.

In certain embodiments, the gasket 604 may have a thickness that is constant across the gasket 604. In certain embodiments, the gasket 604 may have a thickness that increases or decreases based on a position.

For example, in FIG. 6A, the thickness of the substrate 602a may vary based on position. FIG. 6A illustrates that the substrate 602a may include a convex shape that extends away from the gasket 604a. Such a shape may appear as a raised outer surface of a peripheral device. In certain embodiments, the substrate 602a includes a concave shape that extends toward the gasket 604a. Such a shape may appear as a sunken surface of a peripheral device.

FIG. 6A further illustrates that the gasket 604a of a dual shot switch plate 600a may have varying height based on the location of the gasket 604a with respect to the switch plate. The gasket 604a may have varying height and width based on position. The gasket 604a may have varying angles based on position. Varying gasket 604a height and/or width based on position may cause the gasket 604a to form simple or complex three dimensional shapes (e.g., cubes, spheres, steps, pyramids, etc.). The gasket 604a may have acute and/or obtuse angles. The gasket 604a may have flat and/or rounded surfaces. Varying height and width of the gasket 604a at specific positions/regions may allow for increased heat dissipation, light transmission, light blocking, sound transmission, sound dampening, vibration dampening, vibration transmission, etc. Varying height and width of the gasket 604a at specific positions may allow for the surface of the gasket 604a to form designs, wording, logos, etc.

In certain embodiments, less light may be emitted from the center portion of the substrate 602a shown in FIG. 6A because if the increased thickness of the substrate 602a in the center of the cross section. In certain embodiments, more or less light may be emitted from the gasket 604a when the gasket height is increased or decreased based on the material used for the gasket 604a and whether light is more or less capable of traveling through the material of the gasket 604a compared to the substrate 602a.

In certain embodiments, the shape of the gasket 604 also defines the shape of the substrate 602, and vice versa, because of co-molding of the dual shot switch plate 600. For example, the dual shot switch plate 600 may have a predefined shape such that a change to the shape/thickness of the gasket 604 may result in a corresponding change to the shape/thickness of the substrate 602. As just one example, where a protrusion is formed on the gasket 604, a recess or other depressed area may be formed in the substrate 602. This may enable the dual shot switch plate 600 to maintain the predefined shape, while enabling the thickness and/or shape of the substrate 602 and/or gasket 604 to be adjusted. In certain embodiments, the substrate 602 may have a thickness that is constant across the substrate 602. In certain embodiments, the substrate 602 may have a thickness that increases or decreases based on a position. Varying substrate 602 thickness based on position may cause the substrate 602 to form simple or complex three dimensional shapes (e.g., cubes, spheres, steps, pyramids, etc.). The substrate 602 may have acute and/or obtuse angles. The substrate 602 may have flat and/or rounded surfaces. Varying thickness of the substrate 602 at specific positions/regions may allow for increased heat dissipation, light transmission, light blocking, sound transmission, sound dampening, vibration dampening, vibration transmission, etc. Varying thickness of the substrate 602 at specific positions may allow for the surface of the substrate 602 to form designs, wording, logos, etc.

As an example, FIG. 6B illustrates how the heights and width of the gasket 604b may be configured. In a corresponding fashion, the height and width of the substrate 602b may be configured. In certain embodiments, the gasket 604b and or substrate 602b has a certain height and/or width throughout or may vary depending on the position with respect to the dual shot switch plate 600b. For example, FIG. 6B shows that the amount of substrate 602b material between the gasket 604b and an upper surface if the substrate 602b may vary across the upper surface of the substrate 602b. FIG. 6B further shows, that the gasket 604b may have varying levels of width and the width may be dependent on the position with respect to the dual shot switch plate 600b. In certain embodiments, such as in FIG. 6B, the gasket 604b may form the upper surface of the dual shot switch plate 600b in a position. In such a position, the gasket 604b may form a design on the surface of the dual shot switch plate 600b because the gasket 604b may be a different material, color, and/or different texture than the substrate 602b. In such a position, the gasket 604b may allow for more or less light to be transmitted from the lower surface of the dual shot switch plate 600b to the upper surface of the dual shot switch plate 600b depending on the transparency of the substrate 602b and/or the gasket 604b. In certain embodiments, the use of more gasket 604b material may result in more cushioning for the substrate 602b of the dual shot switch plate 600b and may further reduce the sound, vibrations, and/or force transferred to other components in contact with the dual shot switch plate 600b. In certain embodiments, the varying levels of gasket 604b height and/or substrate 602b height may cause a lighting pattern to be formed on the surface of the dual shot switch plate 600b.

As an example, FIG. 6C illustrates a cross section of a computer peripheral device (e.g., keyboard). FIG. 6C illustrates that the substrate 602c may be exposed at the upper surface of the dual shot switch plate 600c and that the gasket 604c may form a lower surface of the dual shot switch plate 600c. Further, FIG. 6C illustrates that the substrate 602c may have a height that decreased in a constant fashion across the surface of the dual shot switch plate 600c. As the substrate 602c height decreased, the gasket 604c height may stay the same or change based on the height of the substrate 602c and/or position relative to the dual shot switch plate 600c. The gasket 604c may be exposed to the outer sides of the dual shot switch plate 600c and may provide force absorption (e.g., when dropped) and/or may provide visual effects (e.g., the gasket 604c itself and/or the light transmission characteristics of the gasket 604c).

As an example, FIG. 6D illustrates a cross section of a computer peripheral device (e.g., keyboard). FIG. 6D illustrates that the substrate 602d and gasket 604d may have varying height and width depending on the position relative to the dual shot switch plate 600d. The height and width of the gasket 604d and substrate 602d may result in a visual effect based on light transmitting from within the peripheral device to the outside of the peripheral device. The gasket 604d may reduce the sound, vibrations, and/or force transferred to other components in contact with the dual shot switch plate 600d.

As an example, FIG. 6E illustrates a cross section of a computer peripheral device (e.g., keyboard). FIG. 6E illustrates that the gasket 604e may include more than one continuous volumes of material and that the gasket 604e material need not be in contact with the other continuous volumes of gasket 604e material. The gasket 604e may protrude from the substrate 602e and/or from one or more surfaces of the dual shot switch plate 600e. The gasket 604e may be positioned within the computer peripheral device based on expected force loads to be experienced by the computer peripheral device. The one or more continuous volumes may protrude out of one or more surfaces of the dual shot switch plate 600e, bottom case, top case, PCB, or other component of the computer peripheral device.

FIGS. 7A-B and 8A-B show examples of a gasket 704 co-molded with a substrate 702. The dual shot switch plate, gasket (e.g., gasket 704, gasket 804), and/or substrate (e.g., substrate 702, substrate 802) may be configured according to embodiments already described above and may include any features described in relation to any of the above-described embodiments (e.g., substrate 602, gasket 604).

In FIG. 7A-B, the examples of the gasket 704 co-molded with the substrate 702 illustrate that the gasket 704 may protrude out of a surface of the substrate 702 (e.g., upper surface and/or lateral surface). The protrusions may help with the molding process by allowing a better flow of melted material, may allow for quicker cooling of the melted material during manufacturing, may allow for more or less light transmission through the dual shot switch plate, may reduce the sound, vibrations, and/or may force transferred to other components in contact with the dual shot switch plate. In certain embodiments, when the gasket 704 protrudes through the substrate 702, the force applied to the substrate 702 can be further distributed to the gasket 704 and/or the protruding gasket 704 may better dampen forces applied to the dual shot switch plate because of direct contact caused with the gasket 704 instead of the substrate.

The tooling slider 706 may control the shape (e.g., profile, cross-sectional shape) of one or more gasket 704 protrusions and/or the shape of the substrate 702 during a molding process of the substrate and/or gasket.

The tooling slider 706 illustrated in FIG. 7B may cause a gasket 704 protrusion to have a certain shape, size, diameter, thickness, etc. The gasket 704 protrusions may be of one or more sizes, shapes, diameters, thicknesses, etc., as shown in FIG. 7B. The tooling slider 706 may cause a dual shot switch plate to be formed like the one shown in FIG. 7A.

The tooling slider 806 in FIG. 8B may cause the dual shot switch plate illustrated in FIG. 8A to be formed where the gasket 804 protrudes through more than one portion of the substrate 802. As illustrated in FIG. 8A, the gasket 804 protrusions and/or substrate 802 apertures may vary across the surface of the dual shot switch plate. For example, in FIG. 8B, the diameter of the apertures in the substrate 802 that the gasket 804 extends through can be varied. Such a configuration may be useful for the manufacturing process, for design appeal, for heat dissipation, for light transmission, for drop or other force protection, etc.

As mentioned above, different lighting effects may be caused based on the shape of the gasket 704 and/or the substrate 702. Further, as mentioned above, different lighting effects may be caused based on the material of the gasket 704 and/or the substrate 702. The lighting effects are illustrated with shaded an unshaded gasket 704 protrusions in FIG. 8A.

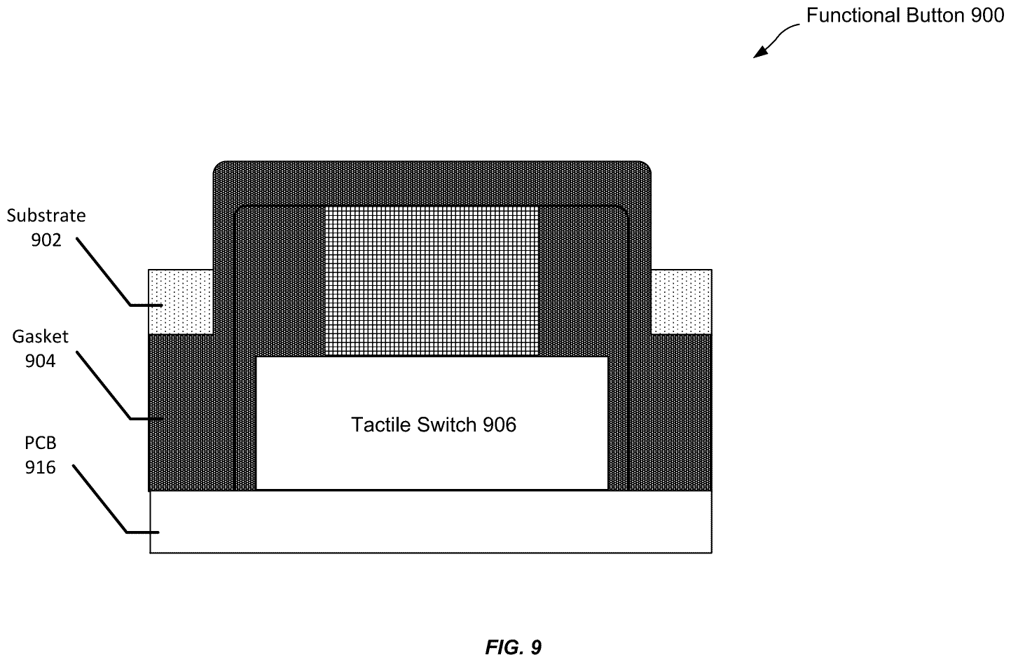

FIG. 9 illustrates an example of a switch plate having a gasket 904 extending through a button aperture. FIG. 9 illustrates a functional button 900. The functional button 900 may include a substrate 902, a gasket 904, a PCB 916, and a tactile switch 906.

The dual shot switch plate, the gasket 904, the substrate 902, and/or the PCB 916 may be configured according to embodiments already described above and may include any features described in relation to any of the above-described embodiments (e.g., substrate 802, gasket 804, PCB 516).

As mentioned above, the substrate 902 and the gasket 904 may form a dual shot switch plate. In one or more portions of the dual shot switch plate, a portion of the substrate 902 may define an aperture. In one or more portions of the dual shot switch plate, a portion of the gasket 904 may extend through the aperture. In certain embodiments, the portion of the gasket 904 extending through the aperture extends fully through the aperture and protrudes above an upper surface of the substrate 902.

The PCB 916 may include one or more components that are in a first position that aligns with the portion of the gasket 904 extending through the substrate 902. For example, in certain embodiments the portion of the substrate 902 may define a button aperture where a button coupled to the PCB 916 may be aligned with the button aperture and may extend through the aperture. In certain embodiments, a portion of the button extends above the upper surface of the substrate 902 and may be covered by the portion of the gasket 904. Such embodiments may allow for PCB 916 components to be manipulated (e.g., pressed) through the gasket 904 and without being obstructed by the substrate 902. The gasket 904 may be capable of being pressed by a user, causing a component under the gasket 904 (e.g., the tactile switch 906) to be depressed and/or otherwise manipulated. Including a component under the gasket 904 that extends through the substrate 902 may allow for dust and water to be kept out of contact with the PCB 916 board or other components internal to a peripheral device. Further, including a component under the gasket 904 may allow for unique lighting effects or sounds effects to occur. Including a component under the gasket 904 may reduce the number of parts used during manufacturing of a peripheral device as key caps or other components to be coupled to a button, switch, light, etc. may be reduced or eliminated.

Although the functional button 900 includes a tactile switch 906, other components, alternatively or additionally, may also be aligned with the substrate 902 aperture that the gasket 904 extends through. In certain embodiments, an LED, a switch, a potentiometer, a light sensor, a touch sensor, a heat sensor, or other component capable of being coupled to the PCB 916 may be aligned with the substrate 902 aperture that the gasket 904 extends through.

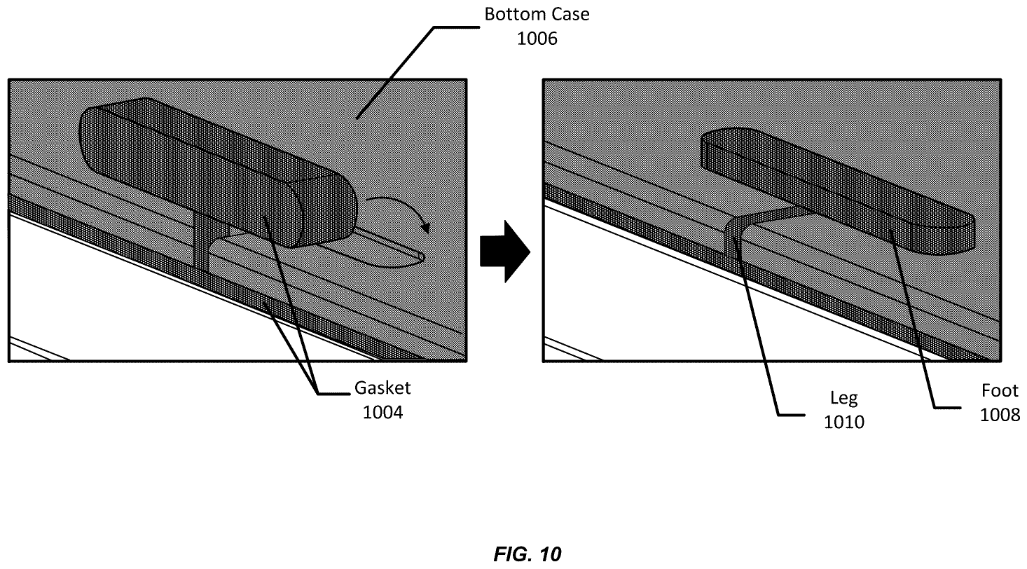

FIG. 10 illustrates an example of a gasket 1004 being used to provide additional structural features to a peripheral device that includes a bottom case 1006.

The gasket 1004 and/or the bottom case 1006 may be configured according to embodiments already described above and may include any features described in relation to any of the above-described embodiments (e.g., gasket 904, bottom case 218).

The gasket 1004 may include any number of protrusions that may extend through or be insertable within apertures formed by another component of the computer peripheral device. For example, as mentioned above, the gasket 1004 may extend through or be insertable within apertures formed by a substrate. In certain embodiments, the gasket 1004 may extend through or be insertable within apertures formed by the bottom case 1006. In certain embodiments, any number of downward-extending protrusions of the gasket 1004 are insertable within apertures formed in the bottom case 1006. Downward-extending protrusions of the gasket 1004 may form one or more supports (e.g., support feet, support stand) that extend below a lower surface of the bottom case 1006.

In certain embodiments, the downward-extending protrusions are in a fixed position. In certain embodiments, the downward-extending protrusions may be moved along one or more axes (e.g., allowing the bottom case 1006 to be configured to be substantially parallel (e.g., the slope of two opposite surfaces being within 0.2 millimeters of one another) or angled with a surface that the bottom case 1006 is in contact with).

In certain embodiments, the gasket 1004 may protrude through one or more apertures formed in a surface of the computer peripheral device that is not the bottom case 1006 or the substrate (e.g., side wall). In certain embodiments, the gasket 1004 may protrude through one or more slots formed in a PCB.

In certain embodiments, gasket 1004 material that extends through an aperture (e.g., aperture of the bottom case) may be the same or a different volume of gasket material that makes up a dual shot switch plate. In certain embodiments, the same volume of gasket 1004 material extends through the bottom case 1006 to form a support and to reduce the time to manufacture the computer peripheral device, reduce the number of components included in the computer peripheral device, etc. In certain embodiments, the different volume of gasket material extends through the bottom case 1006 to form a support structure because the different volume of gasket material is affixed to the dual shot switch plate, the bottom case 1006, or another component of the computer peripheral device. For example, the gasket 1004 may include protrusions that extend beyond a lateral and/or bottom surface of the gasket 1004. The protrusions may each include one or more feet 1008 that are coupled to a main body of the gasket 1004 via one or more legs 1010. As illustrated, each foot 1008 is coupled with the main body via a single leg 1010 that extends beyond the main body of the gasket 1004. The longitudinal axis of each foot 1008 may be arranged at least substantially orthogonal to a longitudinal axis of the respective leg 1010, although other embodiments are possible. The leg 1010 may be thinner than the foot 1008, which may enable the leg 1010 to be bent about the bottom case 1006. For example, the leg 1010 may be inserted through a slot or other opening formed in the bottom case 1006 and folded about the bottom case 1006 such that the foot 1008 is positioned against a bottom surface of the bottom case 1006 (e.g., parallel to the main body of the gasket 1004), thereby enabling the foot 1008 to form a support surface of the bottom case 1006 that helps increase the friction between the keyboard and helps dampen forces between the keyboard and desk or table surface. Affixing the different volume of gasket material may be performed to retain a uniform material look for the computer peripheral device, provide further reduce the sound, vibrations, and/or force transferred to components in contact with the support, while allowing the support to move independent of the dual shot switch plate (e.g., have a pivot).

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art. Indeed, the methods and systems described herein may be embodied in a variety of other forms; furthermore, various omissions, substitutions and changes in the form of the methods and systems described herein may be made without departing from the spirit of the present disclosure. The accompanying claims and their equivalents are intended to cover such forms or modifications as would fall within the scope and spirit of the present disclosure.

Unless specifically stated otherwise, it is appreciated that throughout this specification discussions utilizing terms such as “processing,” “computing,” “calculating,” “determining,” and “identifying” or the like refer to actions or processes of a computer, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computer can include any suitable arrangement of components that provide a result conditioned on one or more inputs. Suitable computers include multipurpose microprocessor-based computing devices accessing stored software that programs or configures the portable device from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computer.

Embodiments of the methods disclosed herein may be performed in the operation of such computers. The order of the blocks presented in the examples above can be varied—for example, blocks can be re-ordered, combined, and/or broken into sub-blocks. Certain blocks or processes can be performed in parallel.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting. Further, “substantially” as used herein when referring to a measurable value such as an amount, a temporal duration, a physical attribute (such as frequency), and the like, also encompasses variations of 20% or 10%, ±5%, or +0.1% from the specified value, as such variations are appropriate to in the context of the systems, devices, circuits, methods, and other implementations described herein and as would be appreciated by one of ordinary skill in the art with the benefit of the present disclosure.

The various features and processes described above may be used independently of one another, or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

What is claimed is:

1. A switch plate for a computer peripheral device, comprising:
a substrate having an upper surface and a lower surface, wherein the substrate comprises a rigid polymeric material; and
a gasket coupled with the lower surface of the substrate, wherein:
the substrate and the gasket are co-molded; and
the gasket comprises a resilient polymeric material.

2. The switch plate for the computer peripheral device of claim 1, wherein:
at least a portion of the gasket extends laterally outward beyond a peripheral surface of the substrate.

3. The switch plate for the computer peripheral device of claim 1, wherein:
the substrate and the gasket define a set of key apertures through a thickness of the switch plate.

4. The switch plate for the computer peripheral device of claim 1, wherein:
the substrate defines at least one aperture through a thickness of the substrate; and
a portion of the gasket extends through the at least one aperture.

5. The switch plate for the computer peripheral device of claim 1, wherein:
the resilient polymeric material comprises a thermoplastic elastomer (TPE).

6. The switch plate for the computer peripheral device of claim 1, wherein:
an interface between the substrate and the gasket is substantially adhesive free.

7. The switch plate for the computer peripheral device of claim 1, wherein:
a thickness of a substantial portion of the gasket is between 1.5 mm and 3.5 mm.

8. A keyboard, comprising:
a switch plate, comprising:
a substrate having an upper surface and a lower surface, wherein the substrate comprises a rigid polymeric material; and
a gasket coupled with the lower surface of the substrate, wherein:
the substrate and the gasket are co-molded;
the gasket comprises a resilient polymeric material; and
the switch plate defines a set of key apertures through a thickness of the switch plate;
a printed circuit board (PCB) disposed below the switch plate;
a set of key switches mounted on the PCB, wherein each of the set of key switches extend through a respective one of the set of key apertures; and
a bottom case that supports the PCB and the switch plate.

9. The keyboard of claim 8, wherein:
the switch plate forms a topmost structural component of the keyboard.

10. The keyboard of claim 8, wherein:
the gasket comprises a number of downward-extending protrusions that are insertable within slots formed within the bottom case to form support feet that extend below a lower surface of the bottom case.

11. The keyboard of claim 8, wherein:
a portion of the gasket is disposed between a lower surface of each of the set of key switches and an upper surface of the PCB.

12. The keyboard of claim 8, wherein:
the switch plate and the bottom case are secured together using a set of limited height screws that limit a default level of compression of the gasket.

13. The keyboard of claim 8, wherein:
a portion of the gasket is present between the substrate and the bottom case at substantially all contact interfaces between the switch plate and the bottom case.

14. The keyboard of claim 8, wherein:
the substrate defines a button aperture;
a portion of the gasket extends through the button aperture and protrudes above a upper surface of the substrate;
the PCB comprises a button that is aligned with the button aperture; and
a portion of the button extends above the upper surface of the substrate and is covered by the portion of the gasket.

15. The keyboard of claim 8, further comprising:
a bottom rubber cushion disposed between the PCB and the bottom case.

16. A computer peripheral device, comprising:
a switch plate, comprising:
a substrate having an upper surface and a lower surface, wherein the substrate comprises a rigid polymeric material; and
a gasket coupled with the lower surface of the substrate, wherein:
the substrate and the gasket are co-molded;
the gasket comprises a resilient polymeric material; and
the switch plate comprises a light transmission region; and
at least one light emitting element disposed beneath the switch plate, wherein the at least one light emitting element is disposed beneath the light transmission region.

17. The computer peripheral device of claim 16, wherein:
the gasket has a variable thickness in the light transmission region.

18. The computer peripheral device of claim 16, wherein:
the light transmission region comprises one or both of translucent materials and transparent materials.

19. The computer peripheral device of claim 16, wherein:
within the light transmission region a portion of the gasket extends to a upper surface of the substrate.

20. The computer peripheral device of claim 16, wherein:
within the light transmission region, the gasket comprises a set of upward extending protrusions.
